(19) United States
(12) Patent Application Publication
(10) Pub. No.: US 2025/0024580 A1
(43) Pub. Date: Jan. 16, 2025

(54) DIRECTING COMPONENT FOR PLASMA TORCH, ASSEMBLY, AND PLASMA TORCH

(71) Applicant: Thermacut, k.s., Uherske Hradiste (CZ)

(72) Inventors: Radim Hunka, Uherske Hradiste (CZ); Petr Vesely, Uherske Hradiste (CZ); Tomas Kusak, Polesovice (CZ)

(21) Appl. No.: 18/689,920

(22) PCT Filed: Sep. 23, 2022
(86) PCT No.: PCT/CZ2022/050099

§ 371 Date: Mar. 7, 2024

(30) Foreign Application Priority Data
Sep. 24, 2021 (CZ) PV 2021-452

(51) Int. Cl. H05H 1/28; B23K 10/00

(52) U.S. Cl. CPC H05H 1/28; B23K 10/00

(57) ABSTRACT

Directing component (1) for a plasma torch, the directing component (1) comprising: a cylindrical portion (17), a conical portion (18), coaxially adjoining the cylindrical portion (17), wherein the cylindrical portion (17) and the conical portion (18) together define a pass-through cavity, a set of mutually angularly spaced apart channels (11) for cooling liquid, each of said channels (11) for cooling liquid having an inlet located at an internal surface of the directing component (1) and an outlet located at an external surface of the directing component (1) and extending at least partially through the conical portion (18), and a set of channels (12) for shield gas, each of said channels (12) for shield gas having an inlet located at an internal surface of the directing component (1) and an inlet at an external surface of the directing component (1) and extending at least partially through the conical portion (18), wherein the channels (11) for cooling liquid form an angle in the range of 30° to 60° with the axis of the directing component (1).

### FIELD OF ART

The invention relates to a directing component for a plasma torch comprising channels for guiding of cooling liquid and shield gas. The invention also relates to an assembly comprising said directing component and a plasma torch comprising said assembly.

### BACKGROUND ART

Plasma torches are used when cutting and welding materials, particularly metallic materials. In general terms, these torches comprise an electrode and a nozzle with an outlet opening which are fixed to the torch head. The torch creates a plasma arc at first between the electrode and the nozzle, whereafter said arc is transferred from the nozzle to the processed part using plasma gas which is fed into the outlet opening of the nozzle. Given the high temperatures of the plasma arc, it is necessary to cool the torch during operation, wherein this cooling is carried out by means of cooling liquid. Parts of the torch can be additionally cooled by processing gases-plasma gas and shield gas.

For instance, EP2236015A2 discloses a plasma arc torch, comprising a component, wherein a channel between an inner surface of the component and the torch body is defined for guiding cooling liquid towards distal end of the nozzle and wherein a channel for guiding shield gas to an outer surface of the nozzle is defined between an outer surface of the component and an inner surface of a member surrounding the component. A disadvantage of such a plasma arc torch is that the cooling by the cooling liquid and by the shield gas inside the torch is not uniform, the cooling is significantly greater around a single coolant inlet than around an outlet, and during operation the coolant can flow around one side of the nozzle in a significantly greater amount than around the other side of the nozzle. The shield gas is supplied through only one supply as well, and the gas is spread around the whole circumference only just before it gets to the nozzle, so that its cooling function is not used as much as it could be. As a result, some parts of the torch are cooled more than needed, and some less than needed, and dead, i.e. uncooled, areas may occur. This results in a shorter lifetime of the torch components.

Efficiency and uniformity of cooling of individual components significantly affects their durability, it is thus necessary to provide such an arrangement of plasma torch, which would ensure uniform cooling of parts made of expensive materials as well as of parts containing materials with relatively lower thermal durability, e.g. electrically insulating materials.

The aim of the invention is to prepare a directing component for a plasma arc torch, which would spread the flow of cooling liquid and the flow of shield gas sideways and ensure as much as possible a uniform cooling of members of the torch.

### SUMMARY OF THE INVENTION

Disadvantages of prior art are eliminated to a large extent by a directing component for a plasma torch, the directing component comprising:
a cylindrical portion,
a conical portion, coaxially adjoining the cylindrical portion,
   wherein the cylindrical portion and the conical portion together define a pass-through cavity,
a set of mutually angularly spaced apart channels for cooling liquid, each of said channels for cooling liquid having an inlet located at an internal surface of the directing component and an outlet located at an external surface of the directing component and extending at least partially through the conical portion, and
a set of channels for shield gas, each of said channels for shield gas having an inlet located at an internal surface of the directing component and an inlet at an external surface of the directing component and extending at least partially through the conical portion,
   wherein axes of the channels for cooling liquid form an angle in the range of 30° to 60° with the axis of the directing component.

Preferably, the axes of the channels for cooling liquid are linear and/or extend at least partially in parallel with the adjacent internal and/or external surface of the conical portion.

It is also advantageous for all embodiments, when the centres of the inlets of the channels for shield gas are arranged at a common circle, the circle having its centre on the axes of the directing component, and/or centres of outlets of channels for shield gas are arranged at a common circle, the circle having its centre on the axes of the directing component, and/or the centres of the inlets of the channels for cooling liquid are arranged at a common circle, the circle having its centre on the axes of the directing component, and/or centres of outlets of channels for cooling liquid are arranged at a common circle, the circle having its centre on the axes of the directing component.

Preferably, the conical portion comprises an internal annular recess in the internal surface, in which internal annular recess the inlets of the channels for cooling liquid are arranged. Preferably, a proximal wall of the internal annular recess is conical with a vertical angle of 60° to 160°, preferably 100° to 140°, and/or

the depth of the internal annular recess corresponds to 0.5 to 1.5 times, preferably to 0.8 to 1.2 times the width of the internal annular recess in the region opposite to a bottom of the recess, and/or
a distal side of the internal annular recess forms an angle of 0° to 10° with a plane perpendicular to the axis of the directing component.

Preferably, a distal end of the cylindrical portion is provided with a first groove in which the outlets of the channels for cooling liquid are arranged.

Preferably, the inlets of the channels for cooling liquid are arranged closer to the plane of the distal end of the directing component than their outlets, and/or are arranged as close to the plane of the distal end of the directing component as the outlets of the channels for shield gas, or closer.

Preferably, the axes of the channels for shield gas form an angle of 10° to 45° with the axis of the directing component.

Preferably, the external surface of the conical portion is provided with a second groove, wherein the outlets of the channels for shield gas are at least partially lead into said second groove.

Disadvantages of prior art are also eliminated to a large extent by an assembly comprising a guiding component for guiding of shield gas for shielding of a plasma arc, wherein said guiding component has a distal conical section and a proximal cylindrical section which together define a pass-through cavity, and the assembly comprises the above directing component, wherein its cylindrical portion surrounds the cylindrical section of the guiding component and its conical portion surrounds the conical section of the guiding component and a space for feeding of shield gas into channels for shield gas is located between the internal surface of the directing component and the external surface of the guiding component.

Disadvantages of prior art are also eliminated to a large extent by a plasma torch comprising:
an electrode,
a nozzle which surrounds a distal end of the electrode,
a cap, which surrounds the distal end of the nozzle and comprises an outlet opening which is coaxial with an outlet opening of the nozzle for exit of a plasma arc,
a retaining component for fastening the cap to the plasma torch,
the above assembly, wherein the internal surface of the distal end of the directing component abuts the external surface of the nozzle via a first sealing ring, wherein inlets of channels for cooling liquid face the external surface of the nozzle and their outlets face the internal surface of the retaining component.

As used herein, the expression proximal presents a portion or a surface, which is closer to the power source when considering the electrical current path (i.e. more distant from the workpiece to be processed), and the expression distal presents a portion or a surface, which is closer to the workpiece to be processed when considering the electrical current path (i.e. further from the power source).

### BRIEF DESCRIPTION OF THE DRAWINGS

FIG. 1 shows a perspective view of an exemplifying embodiment of the directing component.

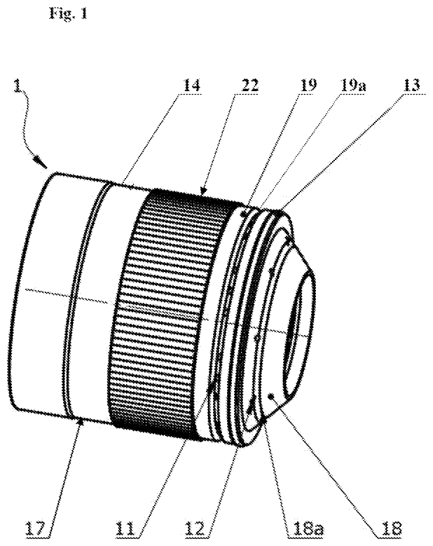

FIG. 2 shows a longitudinal cross-section of a portion of a plasma torch, said portion comprising the directing component.

### DESCRIPTION OF EXEMPLIFYING EMBODIMENTS

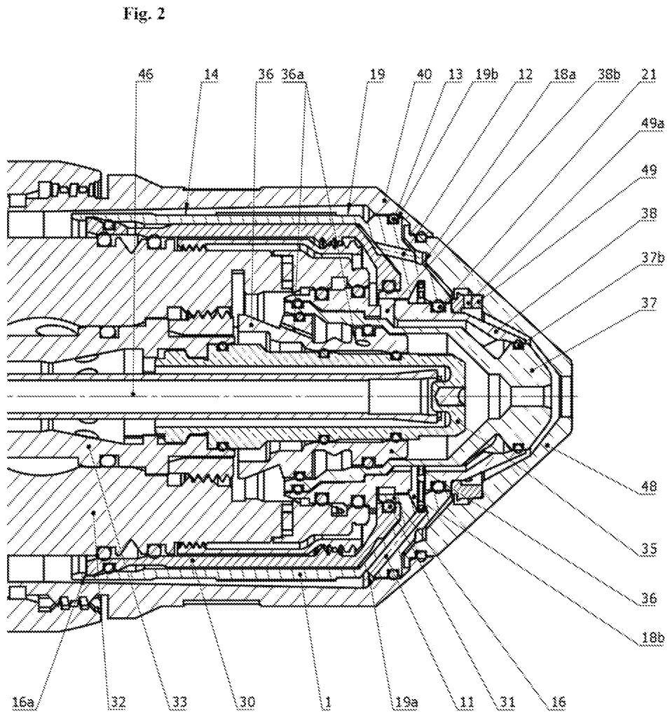

The directing component 1 is intended for use inside a torch assembly depicted in FIG. 2. The directing component 1 comprises a cylindrical portion 17 and a conical portion 18.

An external surface of the cylindrical portion 17 is provided with a first annular recess 14 closer to the proximal end of the cylindrical portion 17. The purpose of the first annular recess 14 is to increase the heat extraction in said area by means of increased amount of liquid which is present in the first annular recess 14 during cooling. The depth and the width of the first annular recess 14 may be selected in accordance with the desired degree of cooling in said area and according to required rigidity of the directing component 1 in said area.

The external surface is provided with a second annular recess 19 closer to the distal end. The second annular recess 19 is provided with a first groove 19a having a rounded bottom.

A sealing groove 19b is arranged in the region between the first groove 19a and the conical portion 18, the sealing groove 19b being intended for housing a sealing 13. The sealing 13 may be made of e.g. rubber and preferably has a form of an O-ring.

In an area between the first annular groove 14 and the second annular groove 19 a grooved region 20 is arranged, the linear grooves extending in the longitudinal direction.

However, an internal surface of the cylindrical portion 17 is provided with a fastening recess 16a in the vicinity of the proximal end, wherein the purpose of said fastening recess 16a a is to allow for a fastening of the directing component 1 to a suitable part of a torch, in this case to a guiding component 30 (see FIG. 2). The fastening recess 16a is thus provided with a radial retaining surface which faces the distal end and by which it abuts on the adjacent proximal end surface of the guiding component 30 being arranged in the directing component 1 when assembled.

The conical portion 18 tapers in the direction from the distal end of the cylindrical part 17 to the distal end of the conical portion, and at the outer side of the directing component 1, the cylindrical portion 17 and the conical portion 18 are linked with each other via a radial annular surface. In other words, the distal end of the conical portion 18 forms a radial surface.

The conical portion 18 is provided with a second groove 18a on an external side, said second groove 18 having an annular shape and a rounded bottom similarly to the first groove 19a.

An internal surface of the conical portion 18 comprises a cylindrical section at its distal end, wherein said cylindrical section is provided with an internal annular recess 18b which widens in the direction from its bottom. Said internal annular recess 18b is intended to increase the area of the cooled surface and to ensure a better discharge of the cooling liquid from the external surface of the nozzle. The proximal side of the internal annular recess 18b forms an angle with a plane perpendicular to the axis of the directing component 1, the angle being in the range of 10° to 60°, while the distal wall forms an angle of 0° to 10° with this plane.

Between the distal end of the directing component 1 and the internal annular recess 18b, the cylindrical section is adapted to abut on a first sealing ring 21 of the nozzle.

The internal surface of the conical portion 18 comprises a conical section at its proximal end, wherein a collar 16 protrudes from the internal surface of the conical portion 18 between the conical section and the cylindrical section.

The collar 16 has an external surface (surface facing away from the axis of the directing component) adapted for a sealing contact with an auxiliary sealing ring 31 for sealing of the contact between the collar 16 and a distal end of the guiding component 30 which is arranged inside the directing component 1.

The directing component 1 is intended for directing and guiding of the cooling liquid and the shield gas inside the torch. In particular, the internal annular recess 18b, channels 11 for cooling liquid (see FIG. 2) and the external surface of the cylindrical portion of the directing component 1 are intended for guiding of the cooling liquid. The channels 11 for cooling liquid extend through the conical portion 18 in parallel to the conical section of the internal surface of the conical portion 18, wherein each of said channels has an inlet in the bottom of the internal annular recess 18b and their outlet partially leads into the first groove 19a on the external surface of the directing component 1.

The channels 11 for cooling liquid are spaced apart such that their axes lie on a conical plane and intersect in a point lying on the axis of the directing component 1. Thus, they form an angle in the range of 30° to 60° with the axis of the directing component 1.

Channels 12 for shield gas are intended for guiding of shield gas (see FIG. 2), said channels 12 for shield gas extending through the conical portion 18, wherein their inlet is located in the conical section of the internal surface of the cylindrical portion 18 and their outlet is partially lead into the second groove 18a on the external surface of the conical portion 18.

The channels 12 for shield gas are spaced apart regularly such that their axes lie on a conical plain and intersect in a point lying on the axis of the directing component 1. Thus they form an angle with the axis of the directing component 1, said angle being smaller than the angle formed by the channels 11 for cooling liquid and being in the range of e.g. 10° to 30°.

Two to four, preferably three channels 11 for cooling liquid are arranged between each pair of neighbouring channels 12 for shield gas.

The channels 11 for cooling liquid as well as the channels 12 for shield gas have a closed cross-section and preferably have a circular cross-section (i.e. they are circular in a cross-section perpendicular to their axes).

The directing component 1 is preferably made of electrically insulating material, e.g. from the group of high-temperature plastics, preferably adapted for operating temperature higher then 150° C. As for the chemical composition, polymer types PSU, PES, PEI, PPS, PEEK etc. may be used.

When assembled, the torch comprises a torch body 32 with an electrode 35 fixed to it via a member 33. In the illustrated embodiment, the electrode 35 is hollow and a cooling tube 46 is arranged in the electrode and intended for defining a trajectory of the liquid for cooling of the electrode 35 at its internal side. A portion of sidewalls of the electrode 35 is surrounded by a swirl ring 36 with distribution passages 36a for guiding of plasma gas.

The distal end of the electrode 35 and the swirl ring 36 are surrounded by a nozzle having an outlet opening for exit of a plasma arc, plasma gas and shield gas. The nozzle comprises an internal component 37 and an external component 38 which surrounds the internal component 37. A cooling space for cooling liquid is formed between the internal component 37 and the external component 38, wherein an inlet into the cooling space extends through an inlet passage 38b through the external component 38 of the nozzle, and an outlet passage is arranged in the external component 38 such that it is angularly rotated by 140° to 180° about the axis of the nozzle and it is arranged such that that it leads into the internal annular recess 18b of the directing component 1 which partially surrounds the external component 38 of the nozzle, wherein the cylindrical section of its internal surface tightly abuts the internal surface of the external component 38 of the nozzle via a sealing ring 21.

A distal end of the cooling space in the nozzle is sealed by a second sealing ring 37 of the nozzle which is arranged between the external surface of the internal component 37 and the internal surface of the external component 38.

The distal end of the nozzle is surrounded by a cap 48, wherein the outlet opening of said cap 48 is arranged coaxially with the outlet opening of the nozzle. A spacer ring 49 is arranged between the cap 48 and the external component 38, wherein said spacer ring 49 defines mutual distance between the external surface of the external component 38 of the nozzle and the internal surface of the cap 48 and comprises radial passages 49a for shield gas.

The cap 48 together with the spacer ring 49 are fixed to the torch by means of a retaining component 40.

When in operation, the plasma gas flows through the distribution passages 36a of the swirl ring 36 into the plasma chamber defined between the internal surface of the internal component 37 of the nozzle and the distal end of the electrode 35 and it flows further together with the plasma arc out through the outlet opening of the nozzle and the outlet opening of the cap 48. Simultaneously, shield gas is fed through the opening in the guiding component 30 into the space between the internal surface of the cylindrical portion 17 of the directing component and the in parallel extending external surface of the guiding component 30. The shield gas is further guided through the channels 12 for shield gas from the region adjacent to the internal surface of the conical portion 18 into the region adjacent to its external surface and further through radial passages 49a of the spacer ring 49 and along the internal surface of the cap 48 (and the external surface of the nozzle) into the outlet opening of the cap 48.

A cooling liquid is simultaneously being fed into the torch. The cooling liquid is fed into the space between the troch body 32 and the internal surface of the guiding body 30 and further through the inlet passage 38b of the external component 38 of the nozzle into the cooling space between the internal surface of the external component 38 and the external surface of the internal component 37 of the nozzle. The cooling liquid is thereafter led away through the outlet passage of the external component 38 into the internal annular recess 18b, whereafter it passes through the directing component 1, particularly through the channels 11 for cooling liquid, and reaches the space between the internal surface of the retaining component 40 and the external surface of the cylindrical portion 17 of the directing component 1, it is led in the distal direction a led away from torch thereafter.

It is clear that a person skilled in the art would readily find further possible alternatives to the embodiments described herein. The scope of the protection is therefore not limited to these exemplifying embodiments but it is rather defined by the appended claims.

1. Directing component for a plasma torch, the directing component comprising:
a cylindrical portion,
a conical portion, coaxially adjoining the cylindrical portion,
wherein the cylindrical portion and the conical portion together define a pass-through cavity,
a set of mutually angularly spaced apart channels for cooling liquid, each of said channels for cooling liquid having an inlet located at an internal surface of the directing component and an outlet located at an external surface of the directing component and extending at least partially through the conical portion, and
a set of channels for shield gas, each of said channels for shield gas having an inlet located at an internal surface of the directing component and an inlet at an external surface of the directing component and extending at least partially through the conical portion,
wherein the channels for cooling liquid form an angle in the range of 30° to 60° with the axis of the directing component.

2. Directing component according to claim 1, wherein axes of the channels for cooling liquid are linear and/or extend at least partially in parallel with the adjacent internal and/or external surface of the conical portion.

3. Directing component according to claim 1, wherein the conical portion comprises an internal annular recess in the internal surface, in which internal annular recess the inlets of the channels for cooling liquid are arranged.

4. Directing component according to claim 3, wherein a proximal wall of the internal annular recess is conical with a vertical angle of 60° to 160°, preferably 100° to 140°, and/or
the depth of the internal annular recess corresponds to 0.5 to 1.5 times, preferably to 0.8 to 1.2 times the width of the internal annular recess in the region opposite to a bottom of the recess, and/or
a distal side of the internal annular recess forms an angle of 0° to 10° with a plane perpendicular to the axis of the directing component.

5. Directing component according to claim 1, wherein a distal end of the cylindrical portion is provided with a first groove in which the outlets of the channels for cooling liquid are arranged.

6. Directing component according to claim 1, wherein the inlets of the channels for cooling liquid are arranged closer to the plane of the distal end of the directing component than their outlets, and/or are arranged as close to the plane of the distal end of the directing component as the outlets of the channels for shield gas, or closer.

7. Directing component according to claim 1, wherein the axes of the channels for shield gas form an angle of 10° to 45° with the axis of the directing component and/or an angle which is smaller than the angle included by the axis of the directing component and the axes of the channels for cooling liquid.

8. Directing component according to claim 1, wherein the external surface of the conical portion is provided with a second groove, wherein the outlets of the channels for shield gas are at least partially lead into said second groove.

9. Assembly comprising a guiding component for guiding of shield gas for shielding of a plasma arc, wherein said guiding component has a distal conical section and a proximal cylindrical section which together define a pass-through cavity, wherein the assembly comprises a directing component according to claim 1, wherein its cylindrical portion surrounds the cylindrical section of the guiding component and its conical portion surrounds the conical section of the guiding component and a space for feeding of shield gas into channels for shield gas is located between the internal surface of the directing component and the external surface of the guiding component.

10. Plasma torch comprising:
an electrode,
a nozzle which surrounds a distal end of the electrode,
a cap which surrounds the distal end of the nozzle and comprises an outlet opening which is coaxial with an outlet opening of the nozzle for exit of a plasma arc,
a retaining component for fastening the cap to the plasma torch, and
an assembly according to claim 9, wherein the internal surface of the distal end of the directing component abuts the external surface of the nozzle via a first sealing ring, wherein inlets of channels for cooling liquid face the external surface of the nozzle and their outlets face the internal surface of the retaining component.
